(19) United States
(12) Patent Application Publication
(10) Pub. No.: US 2022/0297789 A1
(43) Pub. Date: Sep. 22, 2022

(54) Bicycle Wheel Suspension for a Bicycle

(71) Applicant: FAZUA GmbH, Ottobrunn (DE)

(72) Inventors: Herbert Sammüller, Unterföhring (DE); Theodor Piele, Gauting (DE)

(21) Appl. No.: 17/633,142

(22) PCT Filed: Aug. 11, 2020
(86) PCT No.: PCT/EP2020/072538

§ 371 Date: Feb. 4, 2022

(30) Foreign Application Priority Data
Aug. 14, 2019 (DE) 10 2019 121 855.1

(51) Int. Cl. B62K 25/02; B62M 6/65; B60B 27/02

(52) U.S. Cl. CPC B62K 25/02; B62M 6/65; B60B 27/023

(57) ABSTRACT

In an embodiment a bicycle wheel suspension includes a wheel axle having on its both axial ends a respective internal thread, a bicycle frame section of the bicycle, wherein the bicycle frame section comprises a first frame end and a second frame end, a respective bush for each one of the frame ends, wherein the respective bush is arranged concentrically with a through hole and form-fittedly in the through hole and a respective screw for each one of the frame ends, wherein the respective screw is arranged concentrically with the bush and extends form-fittedly through the bush and via the axial end to an inside of the wheel axle, and wherein a screw thread of the screw is in engagement with the internal thread.

This patent application is a national phase filing under section 371 of PCT/EP2020/072538, filed Aug. 11, 2020, which claims the priority of German patent application 102019121855.1, filed Aug. 14, 2019, each of which is incorporated herein by reference in its entirety.

### TECHNICAL FIELD

The invention relates to a bicycle wheel suspension for a bicycle, the bicycle with the bicycle wheel suspension, a hub of the bicycle and a bicycle frame section.

### BACKGROUND

A bicycle wheel suspension for a bicycle comprises conventionally two fork ends that are arranged flush, wherein the bicycle wheel suspension mounts a bicycle wheel on the bicycle. The fork ends for the front bicycle wheel of the bicycle are conventionally mounted on a fork of the bicycle and the fork ends for the rear bicycle wheel of the bicycle are conventionally mounted on the rear area, seen in driving direction of the bicycle, of the frame. A wheel axle of the bicycle wheel is inserted in the fork ends for mounting the bicycle wheel. Subsequently, the wheel axle is mounted on the bicycle by means of two screw nuts or a quick release skewer. It is disadvantageous that the wheel axle can be mounted inclined. This can lead thereto that the bicycle wheel can grind on a brake that belongs to the bicycle wheel.

### SUMMARY OF THE INVENTION

Embodiments provide a bicycle wheel suspension for a bicycle, the bicycle with the bicycle wheel suspension, a hub of the bicycle and a bicycle frame section for which an inclined mounting of a bicycle wheel of the bicycle can be prevented.

The inventive bicycle wheel suspension for a bicycle comprises a wheel axle that comprises on its both axial ends a respective internal thread, wherein the bicycle wheel suspension comprises a bicycle frame section of the bicycle, wherein the bicycle frame section comprises a first frame end and a second frame end, wherein the first frame end and the second frame end respectively comprise a fork end, wherein each one of the axial ends is respectively arranged in one of the fork ends, wherein the first frame end and the second frame end respectively comprise a wall that confines the fork end in axial direction of the wheel axle and that comprises a through hole that communicates with the fork end, wherein the bicycle wheel suspension comprises a respective bush for each one of the frame ends, wherein the respective bush is arranged concentrically with the through hole and form-fittedly in the through hole, wherein the bicycle wheel suspension comprises a respective screw for each one of the frame ends, wherein the respective screw is arranged concentrically with the bush and extends form-fittedly through the bush and via the axial end to the inside of the wheel axle, wherein the screw thread of the screw is in engagement with the internal thread.

By form-fittedly arranging the bush in the through hole on the first frame end and on the second frame end, respectively, and respectively extending the screw form-fittedly through the bush, a position of the respective screw is defined with a high precision on the first frame end as well as on the second frame end. Since the both screw threads of the both screws are in engagement with the corresponding internal thread of the wheel axle, also the position of the wheel axle is defined with the high precision. It is therefore no longer possible to mount a bicycle wheel that belongs to the wheel axle inclined on the bicycle frame section. In addition, by providing the walls, the bicycle frame section is advantageously torsionally stiffer than a bicycle frame section that comprises conventional fork ends without the walls.

Forces are transmitted from the bicycle wheel via the wheel axle, the screws and the bushes to the bicycle frame section during a ride with the bicycle. By providing the bushes, the screws do not contact the bicycle frame section. The bushes have a larger surface in comparison to the screws, so that forces that are transmitted to the bicycle frame section lead to lower pressures on the bicycle frame section as it would be the case if the screws would be immediately mounted on the bicycle frame section. Providing the bushes therefore leads to a low mechanical strain of the bicycle frame section. In addition, the bushes can be exchanged in the case of a damage, which is not possible or complex for the bicycle frame section.

The bicycle frame can be the actual bicycle frame but also a front fork of the bicycle, wherein the front fork is adapted to hold the front bicycle wheel of the bicycle. The fork end is an area that is confined by the bicycle frame in radial direction of the wheel axle and is free from the bicycle frame, wherein wheel axle is to be inserted in the fork end for a mounting of the bicycle wheel on the bicycle frame section. The bicycle frame section can for example be a front fork of the bicycle, wherein the front fork is adapted to hold the front bicycle wheel of the bicycle, or a rear fork of the bicycle, wherein the rear fork is adapted to hold the rear bicycle wheel of the bicycle. The rear fork can comprise chain stays and seat stays of the bicycle. The bicycle frame section can also be two connecting pieces of the bicycle, wherein each of the connecting pieces connects one of the chain stains of the bicycle and one of the seat stays of the bicycle. The front fork can also be a suspension fork that comprises on both arms a respective shock absorber.

For mounting the bicycle on the bicycle frame section, the bicycle wheel is positioned together with the wheel axle, which is mounted on the bicycle wheel, between the first frame end and the second frame end and both axial ends of the wheel axle are inserted by means of a movement of the bicycle wheel in the both fork ends, wherein the movement has a component a radial direction of the wheel axle. Subsequently, the wheel axle is mounted by turning the both screws, wherein the wheel axle thereby orients so that the bicycle wheel is mounted straight on the bicycle frame. For this reason, a grinding of the bicycle wheel on a brake of the bicycle can be prevented, wherein the brake belongs to the bicycle wheel. Since the wheel axle is mounted on the bicycle wheel, it is additionally advantageously not required that the wheel axle is provided in one piece.

The wheel axle preferably comprises two partial axles that are arranged in a distance to each other. One of the two partial axles comprises the one axial end of the wheel axle, wherein the one axial end is arranged in one of the fork ends, and the other of the two partial axles comprises the other axial end of the wheel axle, wherein the other axial end is arranged in the other of the fork ends. The both partial axles can for example be connected to each other by means of a hub casing. The installation space between the both partial axles can be used differently. This is for example relevant, when the bicycle wheel that belongs to the wheel axle comprises an electric motor. The electric motor can here use the installation space between the two partial axles. For example, a gearing of the electric motor, in particular an epicyclic gearing, can be arranged in the installation space between the both partial axles.

The bicycle wheel suspension preferably comprises a respective anti-rotation device for each one of the frame ends, wherein the respective anti-rotation device is arranged in the fork end such that it cannot rotate and comprises an anti-rotation device through hole, wherein the wheel axle is arranged in the anti-rotation device through hole such that it cannot rotate and is arranged in particular form-fittedly in the anti-rotation device through hole. By means of the anti-rotation device a rotation of the wheel axle during a ride with the bicycle can prevented.

The bicycle wheel can be mounted on the bicycle frame section by firstly placing the both anti-rotation devices on the both axial ends of the wheel axle. Subsequently, the bicycle wheel together with the wheel axle and the anti-rotation devices is inserted in the both fork ends as described before, whereby the anti-rotation devices are arranged in the fork ends. Subsequently, the wheel axle is mounted on the bicycle frame section by turning the both screws.

It is particularly preferred that the wheel axle comprises on its both axial ends in a cross section that is perpendicular to the axial direction on its radial outer surface a straight wheel axle section and that the anti-rotation device comprises on its radial inner surface in the cross section a straight anti-rotation device section that is facing towards the straight wheel axle section. It is possible to arrange the wheel axle in a pre-determined rotational angle relative to the bicycle frame section.

It is particularly preferred that the wheel axle comprises for each of the anti-rotation devices a respective stop that is adapted to define the axial position of the anti-rotation device on the wheel axle.

It is preferred that the wheel axle comprises a wheel axle cavity and a wheel axle through hole that is arranged in an outer surface of the wheel axle, wherein the outer surface is outside with respect to the radial direction of the wheel axle, wherein the wheel axle through hole communicates with the wheel axle cavity, wherein an electric wiring of the bicycle is arranged in the wheel axle cavity and guided to the outside of the wheel axle via the wheel axle through hole. In the case that the anti-rotation device and in particular the straight wheel axle section as well as the straight anti-rotation device section are provided, the wheel axle through hole can be provided with a predetermined position in the circumferential direction. For this reason, also the wiring can be guided on the predetermined position out of the wheel axle cavity.

It is preferred that the screw comprises a screw shaft and a screw groove that is oriented in a circumferential direction of the screw and arranged in the screw shaft, wherein the screw comprises a blocking ring that is arranged in the screw groove and protrudes radially outside from the screw shaft, wherein the bush comprises a bush protrusion that protrudes radially inside, wherein the bush protrusion is adapted to contact the blocking ring when the screw is displaced in the axial direction away from the wheel axle, wherein in an extreme position of the screw, in which the screw cannot be screwed further in the wheel axle, an axial distance from the blocking ring to the bush protrusion is longer than an extent that is oriented in the axial direction and along which the screw thread is in engagement with the internal thread. By the bush protrusion contacting the blocking ring, it is advantageously prevented that the screw falls out of the bush when the bicycle wheel is mounted on the bicycle frame or when the bicycle wheel is removed from the bicycle frame. Thereby, the bicycle wheel can be easily mounted on the bicycle frame section or removed from the bicycle frame section. It is for example possible to touch the bush and the screw together with only one hand and to insert the bush and the screw together in the through hole or to take out of the through hole. It is conceivable that the bush protrusion extends along the complete inner circumference of the bush. By the axial distance from the blocking ring to the bush protrusion being longer than the extent that is oriented in the axial direction and along which the screw thread is engagement with the internal thread, it is advantageously prevented that the blocking ring abuts on the bush protrusion before the screw is completely screwed out of the internal thread.

It is particularly preferred that the bush protrusion comprises a first surface that is facing towards the wheel axle and has a normal that is oriented in the axial direction and the bush protrusion comprises a second surface that is facing away from the first surface and encloses together with the first surface an angle of 10° to 80°. It is especially particularly preferred that the angle is from 30° to 60°. For putting together the bush and the screw, firstly the blocking ring is shifted over the screw till the blocking ring ends up in the screw groove. The screw is then inserted via an end of the bush in the bush, wherein the end of the bush is facing away from the wheel axle. The blocking ring contacts the second surface. By using force, the blocking ring is shifted over the bush protrusion till it has passed the bush protrusion. The second surface with its inclination facilitates the shifting over the bush protrusion and the first surface with its normal that is oriented in the axial direction impedes that the screw falls again out of the bush.

The bush preferably comprises a bush head that protrudes from the remaining bush radially outside and abuts on a surface of the wall, wherein the surface of the wall is facing away from the fork end. Thereby, the position of the bush in the axial direction is advantageously defined. It is particularly preferred that the screw comprises a screw head and the bush head comprises a bush head recess, in which the screw head can be at least partially inserted. In particular, the screw head can be completely inserted in the bush head recess.

It is preferred that the bush comprises on its radial outer surface a bush groove that is oriented in circumferential direction of the bush and that the bush comprises a sealing ring that is arranged in the bush groove. The bush groove can extend along the complete outer circumference of the bush. By means of the sealing ring the bush can be mounted in the through hole even if the screw is not in engagement with the wheel axle, which facilitates the mounting of the bicycle wheel on the bicycle frame section and the removal of the bicycle wheel from the bicycle frame section.

The bush preferably comprises a first bush surface that is the surface that is arranged in the through hole and contacts the bicycle frame section, wherein the first bush surface is formed by one circular cylindrical surface or a plurality of circular cylindrical surfaces. For example in the case that the bush groove is not provided, the first bush surface can be formed by only one circular cylindrical surface. For example in the case that the bush groove is provided, the first bush surface can be formed by a plurality of circular cylindrical surfaces. Here, a respective one of the circular cylindrical surfaces can be adjacent to one of the both axial sides of the bush groove.

The bush can preferably comprise a second bush surface that is arranged immediately adjacent to the first bush surface and is the surface that is arranged outside of the through hole and contacts the bicycle frame section, wherein the normal of the second bush surface is parallel to the axial direction of the wheel axle. The second bush surface can be formed by the bush head.

The fork end is preferably open upwards. The term “upwards” relates to the bicycle when it rides on a horizontal underground. It is possible to particularly easily mount the bicycle wheel on the bicycle frame section, by letting the bicycle wheel simply fall from upwards in the fork end. The fork end being open upwards is particularly suited when the bicycle does not comprise a mud guard. When the bicycle comprises a mud guard it is required to dismantle the mud guard in order to mount the bicycle wheel on the bicycle frame end section or to remove from the bicycle frame section. Alternatively, it is conceivable that the fork end is open horizontally or open downwards. The terms “horizontally” and “downwards” also relate to the bicycle when it rides on a horizontal ground.

The bicycle comprises the bicycle wheel suspension and a bicycle frame that comprises the bicycle frame section, wherein the bicycle comprises a hub that comprises the wheel axle, wherein the hub in particular comprises an electric motor.

The inventive hub of a bicycle comprises a wheel axle that comprises on its both axial ends a respective internal thread.

The wheel axle preferably comprises two partial axles that are arranged in a distance to each other. One of the two partial axles can comprise the one axial end of the wheel axle, wherein the one axial end is arranged in one of the fork ends, and the other of the two partial axles can comprise the other axial end of the wheel axle, wherein the other axial end is arranged in the other of the fork ends. The both partial axles can be connected to each other by means of a hub casing. The installation space between the both partial axles can be used differently. This is for example relevant, when the bicycle wheel that belongs to the wheel axle comprises an electric motor. The electric motor can here use the installation space between the two partial axles. For example, a gearing of the electric motor, in particular an epicyclic gearing, can be arranged in the installation space between the both partial axles.

The hub preferably comprises an electric motor.

The bicycle wheel suspension preferably comprises a respective anti-rotation device for each one of the frame ends, wherein the respective anti-rotation device comprises an anti-rotation device through hole, wherein the wheel axle is arranged in the anti-rotation device through hole such that it cannot rotate. It is particularly preferred that the wheel axle comprises on its both axial ends in a cross section that is perpendicular to the axial direction on its radial outer surface a straight wheel axle section and that the anti-rotation device comprises on its radial inner surface in the cross section a straight anti-rotation device section that is facing towards the straight wheel axle section.

It is preferred that the wheel axle comprises a wheel axle cavity and a wheel axle through hole that is arranged in an outer surface of the wheel axle, wherein the outer surface is outside with respect to the radial direction of the wheel axle, wherein the wheel axle through hole communicates with the wheel axle cavity, wherein an electric wiring of the bicycle is arranged in the wheel axle cavity and guided to the outside of the wheel axle via the wheel axle through hole.

The bicycle frame section comprises a first frame end and a second frame end that respectively comprise a respective fork end and a respective wall that axially confines the fork end and comprises a through hole that communicates with the fork end. The both fork ends can be arranged flush in a direction perpendicular to a driving direction of a bicycle, wherein the bicycle comprises the bicycle frame section.

The bicycle frame section preferably comprises a respective bush for each one of the frame ends, wherein the respective bush is arranged concentrically with the through hole and form-fittedly in the through hole. The bicycle wheel section preferably comprises a respective screw for each one of the frame ends, wherein the respective screw is arranged concentrically with the bush and extends form-fittedly through the bush.

It is preferred that the screw comprises a screw shaft and a screw groove that is oriented in a circumferential direction of the screw and arranged in the screw shaft, wherein the screw comprises a blocking ring that is arranged in the screw groove and protrudes radially outside from the screw shaft, wherein the bush comprises a bush protrusion that protrudes radially inside, wherein the bush protrusion is adapted to contact the blocking ring when the screw is displaced in the axial direction away from the wheel axle. It is particularly preferred that the bush protrusion comprises a first surface that is facing towards the wheel axle and has a normal that is oriented in the axial direction and the bush protrusion comprises a second surface that is facing away from the first surface and encloses together with the first surface an angle of 10° to 80°, in particular an angle from 30° to 60°.

The bush preferably comprises a bush head that protrudes from the remaining bush radially outside and abuts on a surface of the wall, wherein the surface of the wall is facing away from the fork end. It is preferred that the screw comprises a screw head and the bush head comprises a bush head recess, in which the screw head can be at least partially inserted. In particular, the screw head can be completely inserted in the bush head recess.

It is preferred that the bush comprises on its radial outer surface a bush groove that is oriented in circumferential direction of the bush and that the bush comprises a sealing ring that is arranged in the bush groove.

The bush preferably comprises a first bush surface that is the surface that is arranged in the through hole and contacts the bicycle frame section, wherein the first bush surface is formed by one circular cylindrical surface or a plurality of circular cylindrical surfaces. For example in the case that the bush groove is not provided, the first bush surface can be formed by only one circular cylindrical surface. For example in the case that the bush groove is provided, the first bush surface can be formed by a plurality of circular cylindrical surfaces. Here, a respective one of the circular cylindrical surfaces can for example be adjacent to one of the both axial sides of the bush groove. The bush can preferably comprise a second bush surface that is arranged immediately adjacent to the first bush surface and is the surface that is arranged outside of the through hole and contacts the bicycle frame section, wherein the normal of the second bush surface is parallel to the axial direction of the wheel axle. The second bush surface can be formed by the bush head.

The fork end is preferably open upwards. The term “upwards” relates to the bicycle when it rides on a horizontal underground. Alternatively, it is conceivable that the fork end is open horizontally or open downwards. The terms “horizontally” and “downwards” also relate to the bicycle when it rides on a horizontal underground.

### BRIEF DESCRIPTION OF THE DRAWINGS

In the following the invention is explained by using the attached schematic drawings.

FIG. 1 shows a longitudinal section through a part of an inventive bicycle wheel suspension;

FIG. 2 shows the section C-C shown in FIG. 1;

FIG. 3 shows the section D-D shown in FIG. 1;

FIG. 4 shows the detail A shown in FIG. 1;

FIG. 5 shows a larger section of the bicycle wheel suspension than FIG. 1; and

FIG. 6 shows a longitudinal section through a hub and the bicycle wheel suspension.

### DETAILED DESCRIPTION OF ILLUSTRATIVE EMBODIMENTS

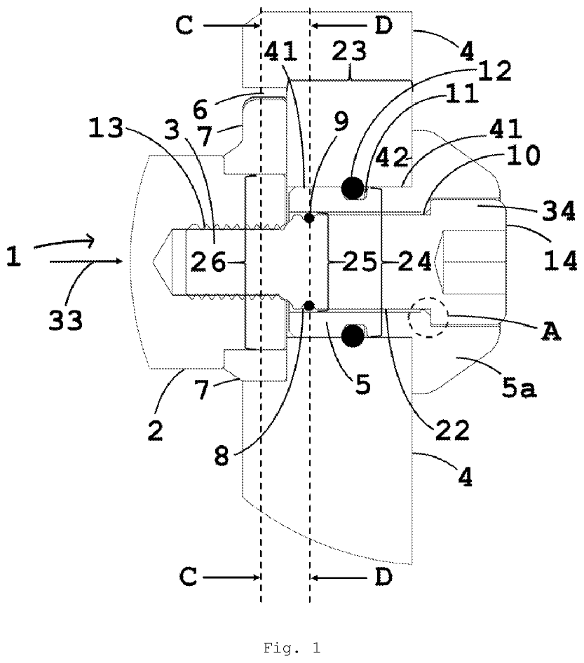

As it can be seen from FIGS. 1 to 6, the inventive bicycle wheel suspension 1 for a bicycle comprises a wheel axle 2 and a bicycle frame section 4 of the bicycle, wherein the bicycle frame section 4 comprises a first frame end 27 and a second frame end 28. In addition, the bicycle wheel suspension 1 comprises a respective bush 5 for each one of the frame ends 27, 28 and a respective screw 3 for each one of the frame ends 27, 28. The first frame end 27 and the second frame end 28 respectively comprise a fork end 6, in which a respective one of the axial ends of the wheel axle 2 is arranged, and a respective wall 23 that confines the fork end 6 in axial direction 33 of the wheel axle 2 and that comprises a through hole 24 that communicates with the fork end 6. The wheel axle 2 comprises on its both axial ends a respective internal thread. The respective bush 5 is arranged concentric with the corresponding through hole 24 and form-fittedly in the corresponding through hole 24. The respective screw 3 is arranged concentrically with the corresponding bush 5 and extends form-fittedly through the corresponding bush 5 and via the corresponding axial end to the inside of the wheel axle 2, wherein the screw thread 13 of the screw 3 is in engagement with the internal thread. It is conceivable that the screw 3 contacts the bicycle frame section 4 nowhere, as it is shown for example in FIG. 1. From FIG. 3 it can be seen that the through hole 24 can be confined by the wall 23 along its complete circumference.

FIG. 1 shows that it is conceivable that a bush through hole 25 of the bush 5 has in a cross section that is arranged perpendicular to the axial direction 33 and extends through an end of the bush 5, wherein the end of the bush 5 is facing towards the wheel axle 2, a smaller cross section than the wheel axle 2 in a cross section that is arranged perpendicular to the axial direction 33 and extends through an end of the wheel axle 2, wherein the end of the wheel axle 2 is facing towards the bush 5. It is also conceivable that the through hole 24 has in a cross section that is arranged perpendicular to the axial direction 33 and extends through an end of the wall 23, wherein the end of the wall 23 is facing towards the wheel axle 2, a smaller cross section than the wheel axle 2 in a cross section that is arranged perpendicular to the axial direction 33 and extends through an end of the wheel axle 2, wherein the end of the wheel axle 2 is facing towards the wall 23. Thereby, it can be prevented that the wheel axle 2 enters in the through hole 24. In addition, it is conceivable that the internal thread is arranged concentrically in the wheel axle 2. The bush 5 can for example comprise aluminium, steel and/or stainless steel or can consist out of aluminium, steel and/or stainless steel.

The bicycle frame section 4 is a partial area of a bicycle frame of a bicycle, wherein the bicycle frame can be the actual bicycle frame but also a front fork of the bicycle, wherein the front fork is adapted to hold the front bicycle wheel of the bicycle. The bicycle frame section 4 can for example be a front fork of the bicycle, wherein the front fork is adapted to hold the front bicycle wheel of the bicycle, or a rear fork of the bicycle, wherein the rear fork is adapted to hold the rear bicycle wheel of the bicycle. The rear fork can comprise chain stays and seat stays of the bicycle. The bicycle frame section can also be two connecting pieces of the bicycle, wherein each of the connecting pieces connects one of the chain stains of the bicycle and one of the seat stays of the bicycle. The fork end 6 is an area that is confined by the bicycle frame in radial direction of the wheel axle 2 and is free from the bicycle frame, wherein the wheel axle 2 is to be inserted in the fork end 6 for a mounting of the bicycle wheel on the bicycle frame section 4. It is conceivable that the bicycle wheel is mounted on the wheel axle 2 when the bicycle wheel is mounted on the bicycle frame section 4 as well as when the bicycle wheel is not mounted on the bicycle frame section 4.

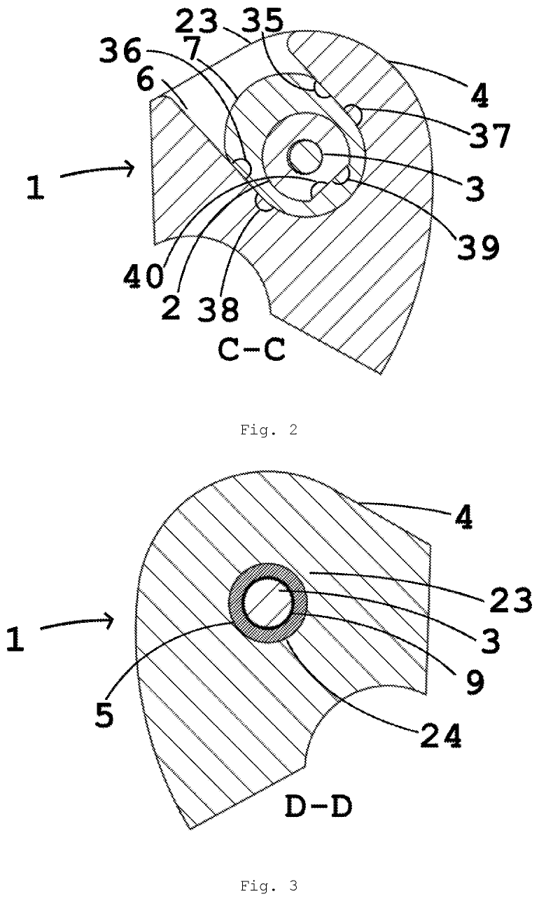

FIGS. 1 and 2 show that the bicycle wheel suspension 1 can comprise a respective anti-rotation device 7 for each one of the frame ends 27, 28. The anti-rotation device 7 is arranged in the fork end 6 such that it cannot rotate and comprises an anti-rotation device through hole 26 in which the wheel axle 2 is arranged such that the wheel axle 2 cannot rotate. It is also conceivable that the wheel axle 2 is arranged form-fittedly in the anti-rotation device through hole 26. As it can be seen from FIG. 2, the first frame end 27 and the second frame end 28 can respectively comprise a first straight frame surface 35 and a second straight frame surface 36 that are arranged parallel to each other and confine the fork end 6 in a direction transversally to the axial direction 33. In order to prevent a rotation of the anti-rotation device 7 relative to the corresponding frame end 27, 28, the anti-rotation device 7 can comprise a first straight anti-rotation device surface 37 and a second straight anti-rotation device surface 38 that are arranged parallel to each other and the distance from the first straight anti-rotation device surface 37 to the second straight anti-rotation device surface 38 corresponds substantially to the distance from the first straight frame surface 35 to the second straight frame surface 36. Thereby, the anti-rotation device 7 is longitudinally displaceable in the fork end 6 but the anti-rotation device 7 is not rotatable in the fork end 6.

In FIG. 1 it is shown that the wheel axle 2 can comprise for each of the anti-rotation devices 7 a respective stop that is adapted to define the axial position of the anti-rotation device 7 on the wheel axle 2. It is conceivable that the stop is formed by the wheel axle 2 having on its axial end a smaller cross section than in an area that is positioned at a distance from the axial end. It is also conceivable that the stop is positioned at a distance to the fork end 6, as it is shown in FIG. 1. The anti-rotation device 7 thereby extends over an axial area that is longer than the axial extension of the fork end 6. FIG. 1 shows that the anti-rotation device 7 can be arranged on its side facing away the wall 23 radial outside flush with the first frame end 27 and with the second frame end 28, respectively, and can become wider towards radial inside.

As it can be seen from FIG. 2, the wheel axle 2 can comprise on its both axial ends in a cross section that is perpendicular to the axial direction 33 on its radial outer surface a straight wheel axle section 39 and the anti-rotation device 7 can comprise on its radial inner surface in the cross section a straight anti-rotation device section 40 that is facing towards the straight wheel axle section 39. In addition, it is conceivable that the remaining wheel axle section and the remaining anti-rotation device section respectively have the shape of circular arc in the cross section that is perpendicular to the axial direction 33.

FIGS. 1 and 3 show that the screw 3 can comprise a screw shaft 22 and a screw groove 8 that is oriented in a circumferential direction of the screw 3, arranged in the screw shaft 22 and extends along the complete circumference of the screw 3, wherein the screw 3 can comprise a blocking ring 9 that is arranged in the screw groove 8 and protrudes radially outside from the screw shaft 22, wherein the bush 5 can comprise a bush protrusion 10 that protrudes radially inside, wherein the bush protrusion 10 is adapted to contact the blocking ring 9 when the screw 3 is displaced in the axial direction 33 away from the wheel axle 2, wherein in an extreme position of the screw 3, in which the screw 3 cannot be screwed further in the wheel axle 2, an axial distance from the blocking ring 9 to the bush protrusion 10 is longer than an extent that is oriented in the axial direction 33 and along which the screw thread 13 is in engagement with the internal thread. It is conceivable that the bush protrusion 10 extends along the complete inner circumference of the bush 5. The blocking ring 9 can for example comprise spring steel or consist out of spring steel.

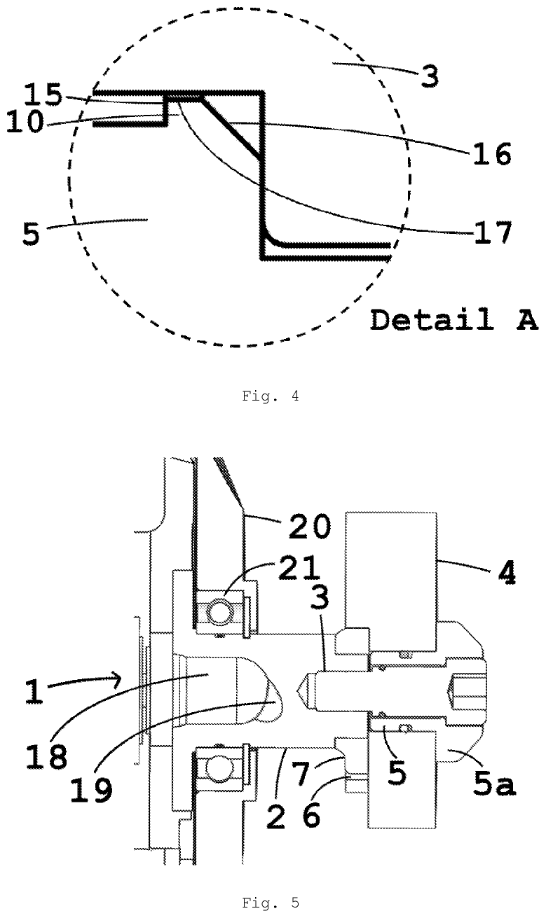

FIGS. 1 and 4 show that the bush protrusion 10 can comprise a first surface 15 that is facing towards the wheel axle 2 and has a normal that is oriented in the axial direction 33 and that the bush protrusion 19 can comprise a second surface 16 that is facing away from the first surface 15 and encloses together with the first surface an angle of 10° to 80°, in particular an angle from 30° to 60°. In the case that the bush protrusion 10 extends along the complete inner circumference of the bush 5, the second surface 16 has the shape of an envelope of a truncated cone. It is also conceivable that the bush protrusion 10 comprises a ring surface 17 that is arranged in the axial direction 33 between the first surface 15 and the second surface 16 and is the surface of the bush protrusion 10 that is the most protruding and in particular is the surface of the bush 5 that is the most protruding.

As it is shown in FIG. 1, the bush 5 can comprise a bush head 5a that protrudes from the remaining bush 5 radially outside and abuts on a surface of the wall 23, wherein the surface of the wall 23 is facing away from the fork end 6. In addition, it is conceivable that the screw 3 comprises a screw head 14 and the bush head 5a comprises a bush head recess 34, in which the screw head 14 can be at least partially inserted and in particular completely inserted. The bush head recess 34 can be larger in a cross section that is perpendicular to the axial direction 33 than the bush through hole 25 in a cross section that is perpendicular to the axial direction 33 and arranged on and end that is facing towards the wheel axle 2. The screw 3 can for example be a hexagon socket screw or a torx screw. In the case that the bush protrusion 10 is provided, it is conceivable that the second surface 16 of the bush protrusion extends 10 to the bush head recess 34. It is also conceivable that the second surface 16 extends further to radial outside than the first surface 15. In the case that the screw shaft 22 is provided, the screw shaft 22 can be arranged in the axial direction 33 between the screw thread 13 and the screw head 14.

FIG. 1 shows that the bush 5 can comprise on its radial outer surface a bush groove 11 that is oriented in circumferential direction of the bush 5 and that the bush 5 comprises a sealing ring 12 that is arranged in the bush groove 11. It is conceivable that the bush groove 11 extends along the complete outer circumference of the bush 5. Furthermore, it is conceivable that the sealing ring 12 is flexible and in an unstressed state thicker than the extension of the bush groove 11 in radial direction of the wheel axle 2. The bush 5 can thereby be mounted on the bicycle frame 4 by means of the sealing ring 12. The sealing ring 12 can for example comprise PTFE, polyoxymethylene, hydrolysis-resistant polyurethane (HPU), polyurethane, silicone and/or polyamide or consist of the compounds mentioned before.

As it can be seen from FIG. 1, the bush 5 can comprise a first bush surface 41 that is the surface that is arranged in the through hole 24 and contacts the bicycle frame section 4, wherein the first bush surface 41 is formed by one circular cylindrical surface or a plurality of circular cylindrical surfaces. For example in the case that the bush groove 11 is not provided, the first bush surface 41 can be formed by only one circular cylindrical surface. For example in the case that the bush groove 11 is provided, as it is the case in FIG. 1, the first bush surface 41 can be formed by a plurality of circular cylindrical surfaces. Here, a respective one of the circular cylindrical surfaces can be adjacent to one of the both axial sides of the bush groove 11. The bush 5 can additionally comprise a second bush surface 42 that is arranged immediately adjacent to the first bush surface 41 and is the surface that is arranged outside of the through hole 24 and contacts the bicycle frame section 4, wherein the normal of the second bush surface 42 is parallel to the axial direction of the wheel axle 2. The second bush surface can be formed by the bush head 5a. By providing the first bush surface 41 and the second bush surface 42, forces are transmitted from the bush 5 to the bicycle frame section 4 and vice versa only via surfaces that are oriented in the axial direction 33 or in radial direction with reference to the wheel axle 2. The bush 5 can thereby not be displaced.

From FIG. 2, it can be seen that the fork end 6 is open upwards. The term “upwards” relates to the bicycle that comprises the fork end 6, when the bicycle drives on a horizontal underground. It is conceivable that the fork end 6 is inclined open upwards, as it is shown in FIG. 2. It is alternatively also conceivable, that the fork end 6 is perpendicular open upwards. Alternatively, it is conceivable that the fork end 6 is open horizontally or open downwards. The terms “horizontal” and “downwards” also relate to the bicycle when it drives on a horizontal underground. When the fork end 6 is open downwards, it is conceivable that the fork end 6 is inclined open downwards or perpendicular open downwards.

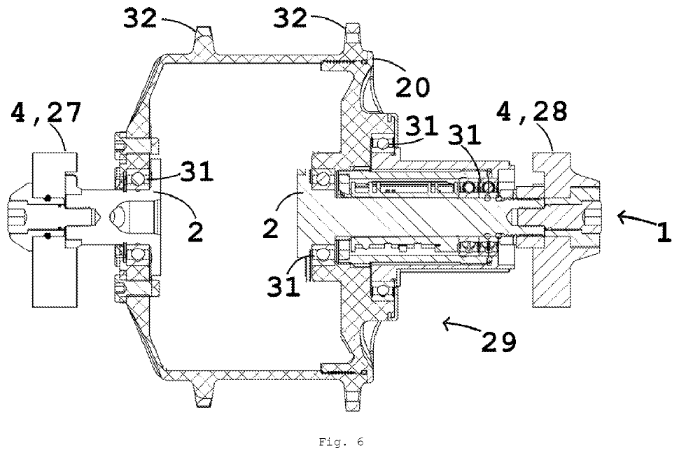

FIG. 5 shows a larger section of the bicycle wheel suspension 1 than FIG. 1. It can be recognized that the wheel axle 2 can comprise a wheel axle cavity 18 and a wheel axle through hole 19. The wheel axle cavity 18 is arranged in the inside of the wheel axle 2 and the wheel axle through hole 19 is arranged in a surface arranged outside in radial direction of the wheel axle 2 and communicates with the wheel axle cavity 18. An electric wiring of the bicycle can be arranged in the wheel axle cavity 18 and is guided via the wheel axle through hole 19 to the outside of the wheel axle 2.

In FIG. 6, a hub 29, in which the wheel axle 2 is arranged, and the bicycle wheel suspension 1 are shown. The hub 29 can comprise a hub casing 20. The hub 29 can comprise several bearings 21 by means of which the hub casing 20 is born such that it can rotate relative to the wheel axle 2. In addition, the hub casing 20 also comprises two spoke flanges 32 that are provided to be connected to spokes of the bicycle wheel.

As is can be seen from FIG. 6, the wheel axle 2 can comprise two partial axles that are arranged in a distance to each other. One of the two partial axles comprises the one axial end of the wheel axle 2, wherein the one axial end is arranged in one of the fork ends 6, and the other of the two partial axles comprises the other axial end of the wheel axle 2, wherein the other axial end is arranged in the other of the fork ends 6. The both partial axles can for example be connected to each other by means of a hub casing 20. The installation space between the both partial axles can be used differently. This is for example relevant, when the bicycle wheel that belongs to the wheel axle 2 comprises an electric motor. The electric motor can here use the installation space between the two partial axles. For example, a gearing of the electric motor, in particular an epicyclic gearing, can be arranged in the installation space between the both partial axles.

From FIG. 6 it can be seen that the diameter of the through hole 24 of the first frame end 27 can be as long as the diameter of the through hole 24 of the second frame end 28.

Although the invention has been illustrated and described in detail by means of the preferred embodiment examples, the present invention is not restricted by the disclosed examples and other variations may be derived by the skilled person without exceeding the scope of protection of the invention.

1.-17. (canceled)

18. A bicycle wheel suspension for a bicycle, the bicycle wheel suspension comprising:
a wheel axle that comprises on its both axial ends a respective internal thread;
a bicycle frame section of the bicycle, wherein the bicycle frame section comprises a first frame end and a second frame end, wherein the first frame end and the second frame end respectively comprise a fork end, wherein each one of the axial ends is respectively arranged in one of the fork ends, and wherein the first frame end and the second frame end respectively comprise a wall that confines the respective fork end in axial direction of the wheel axle and that comprises a through hole that communicates with the fork end;
a respective bush for each one of the frame ends, wherein the respective bush is arranged concentrically with the through hole and form-fittedly in the through hole; and
a respective screw for each one of the frame ends, wherein the respective screw is arranged concentrically with the bush and extends form-fittedly through the bush and via the axial end to an inside of the wheel axle, and wherein a screw thread of the screw is in engagement with the internal thread.

19. The bicycle wheel suspension according to claim 18, wherein the wheel axle comprises two partial axles that are arranged in a distance to each other.

20. The bicycle wheel suspension according to claim 18, further comprising a respective anti-rotation device for each one of the frame ends, wherein the respective anti-rotation device is arranged in the fork end such that it is not rotatable and comprises an anti-rotation device through hole, and wherein the wheel axle is arranged in the anti-rotation device through hole such that it is not rotatable and is arranged form-fittedly in the anti-rotation device through hole.

21. The bicycle wheel suspension according to claim 20, wherein the wheel axle comprises on its both axial ends in a cross section that is perpendicular to the axial direction on its radial outer surface a straight wheel axle section, and wherein the anti-rotation device comprises on its radial inner surface in the cross section a straight anti-rotation device section facing towards the straight wheel axle section.

22. The bicycle wheel suspension according to claim 20, wherein the wheel axle comprises for each of the anti-rotation devices a respective stop configured to define an axial position of the anti-rotation device on the wheel axle.

23. The bicycle wheel suspension according to claim 18, wherein the wheel axle comprises a wheel axle cavity and a wheel axle through hole that is arranged in an outer surface of the wheel axle, wherein the outer surface is outside with respect to a radial direction of the wheel axle, wherein the wheel axle through hole communicates with the wheel axle cavity, and wherein an electric wiring of the bicycle is arranged in the wheel axle cavity and is guided to an outside of the wheel axle via the wheel axle through hole.

24. The bicycle wheel suspension according to claim 18, wherein the screw comprises a screw shaft and a screw groove that is oriented in a circumferential direction of the screw and arranged in the screw shaft, wherein the screw comprises a blocking ring that is arranged in the screw groove and protrudes radially outside from the screw shaft, wherein the bush comprises a bush protrusion that protrudes radially inside, wherein the bush protrusion is adapted to contact the blocking ring when the screw is displaced in the axial direction away from the wheel axle, and wherein in an extreme position of the screw, in which the screw is not further turnable in the wheel axle, an axial distance from the blocking ring to the bush protrusion is longer than an extent that is oriented in the axial direction and along which the screw thread is in the engagement with the internal thread.

25. The bicycle wheel suspension according to claim 24, wherein the bush protrusion comprises a first surface facing towards the wheel axle and has a normal oriented in the axial direction, and a second surface facing away from the first surface and that encloses together with the first surface an angle of 10° to 80°.

26. The bicycle wheel suspension according to claim 18, wherein the bush comprises a bush head that protrudes from a remaining bush radial outside and abuts on a surface of the wall, and wherein the surface of the wall is facing away from the fork end.

27. The bicycle wheel suspension according to claim 26, wherein the screw comprises a screw head and the bush head comprises a bush head recess, in which the screw head is at least partially insertable.

28. The bicycle wheel suspension according to claim 18, wherein the bush comprises on its radial outer surface a bush groove that is oriented in circumferential direction of the bush and the bush comprises a sealing ring that is arranged in the bush groove.

29. The bicycle wheel suspension according to claim 18, wherein the fork end is open upwards.

30. The bicycle comprising:
the bicycle wheel suspension according to claim 18;
a bicycle frame comprising the bicycle frame section; and
a hub comprising the wheel axle,
wherein the hub comprises an electric motor.

31. A hub of a bicycle comprising:
a wheel axle comprising on its both axial ends a respective internal thread.

32. The hub according to claim 31, wherein the wheel axle comprises two partial axles that are arranged in a distance to each other.

33. The hub according to claim 31, further comprising an electric motor.

34. A bicycle frame section comprising:
a first frame end and a second frame end respectively comprising a fork end and a wall that axially confines the fork end and comprises a through hole that communicates with the fork end.
